(19) United States
(12) Patent Application Publication
(10) Pub. No.: US 2010/0162496 A1
(43) Pub. Date: Jul. 1, 2010

(54) GOODS GUIDING DEVICE AND METHOD

(75) Inventors: Osamu NAKAMURA, Kahoku (JP); Masakazu Kawada, Kahoku (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/640,408

(22) Filed: Dec. 17, 2009

(30) Foreign Application Priority Data
Dec. 26, 2008 (JP) 2008-332891

(51) Int. Cl. B65G 69/30; E01D 1/00

(52) U.S. Cl. 14/69.5

(57) ABSTRACT

A device for guiding goods to be fed between a first floor and a second floor over a gap formed between the first and second floors, the device includes: a first plate member to be placed on the first floor; a second plate member to be placed on the second floor, at least one of the first and second plate members having a hook portion engageable with a groove; and a hinge connecting the first plate member and the second plate member, the hinge protruding downwardly from the surfaces of the first and second plate member, the hinge having a size adapted to the gap such that when the device placed between the first and second floors, the hinge can be accommodated within the gap, and engagement of the hinge with the gap and the hook portion provides a stable guide surface for feeding the goods.

### CROSS-REFERENCE TO RELATED APPLICATION

This application is based upon and claims the benefit of priority of the prior Japanese Patent Application No. 2008-332891, filed on Dec. 26, 2008, the entire contents of which are incorporated herein by reference.

### FIELD

A certain aspect of the embodiments discussed herein relates to a technique of guiding goods to be fed between a first floor and a second floor over a gap.

### BACKGROUND

A goods guiding device is used to guide goods, especially heavy goods, to be fed between a landing floor and a car floor of an elevator so that goods can be smoothly carried into and out of the elevator.

FIGS. 11 to 13 illustrate a conventional goods guiding device, and illustrate side sections of a landing floor A, a car floor B, and a floor plate 101 together with a carrier M and an article (goods) C to be carried. The article C can be a kind of heavy goods, and hereinafter goods are just called the article C.

Hitherto, the floor plate 101 formed by a plate-shaped member of rectangular side section, as illustrated in FIG. 11, has been used as a goods guiding device. As illustrated in FIG. 11, a slope is formed by placing one end of the floor plate 101 on the landing floor A of the elevator and placing the other end thereof on the car floor B, thereby eliminating a level difference formed between the landing floor A and the car floor B of the elevator and guiding the article C.

The carrier M moves the article C, which has casters C1 and C2 at the bottom, over the floor plate 101, for example, by pushing the article C, and thereby moves the article C between the landing floor A and the car floor B.

[Patent Document 1] Japanese Laid-open Patent Publication No. 10-101270

### SUMMARY

According to an aspect of an embodiment, a device for guiding goods to be fed between a first floor and a second floor over a gap formed between the first and second floors, the device includes: a first plate member to be placed on the first floor for supporting and guiding the goods fed from the first floor; a second plate member to be placed on the second floor for supporting and guiding the goods fed to the second floor, at least one of the first and second plate members having a hook portion engageable with a groove formed on at least one of the first and second floors; and a hinge connecting the first plate member and the second plate member, the hinge protruding downwardly from the surfaces of the first and second plate member for supporting and guiding the goods, the hinge having a size adapted to the gap such that when the device placed between the first and second floors, the hinge can be accommodated within the gap, and engagement of the hinge with the gap and the hook portion with the groove provides a stable guide surface for feeding the goods.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic view illustrating the configuration of a goods guiding device according to an embodiment;

FIG. 2 is a schematic view illustrating the configuration of the goods guiding device of the embodiment;

FIG. 3 is a view illustrating the dimensions of a floor plate in the goods guiding device of the embodiment;

FIG. 4 is a view explaining the dimensions of a floor plate in the goods guiding device of the embodiment;

FIG. 5 is a view explaining the rotational moment produced in the goods guiding device of the embodiment;

FIG. 6 is a view explaining the rotational moment produced in the goods guiding device of the embodiment;

FIG. 7 is a view explaining the rotational moment produced in the goods guiding device of the embodiment;

FIG. 8 is a side view explaining a method for using the goods guiding device of the embodiment;

FIG. 9 is a schematic view illustrating the configuration of a modification of the goods guiding device of the embodiment;

FIG. 10 is a schematic view illustrating the configuration of a modification of the goods guiding device of the embodiment;

FIG. 11 is a view illustrating a conventional goods guiding device;

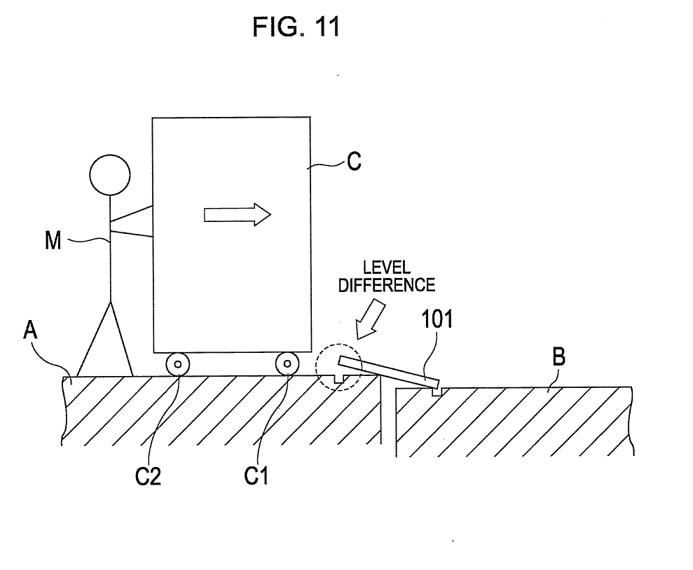

FIG. 12 is a view illustrating the conventional goods guiding device; and

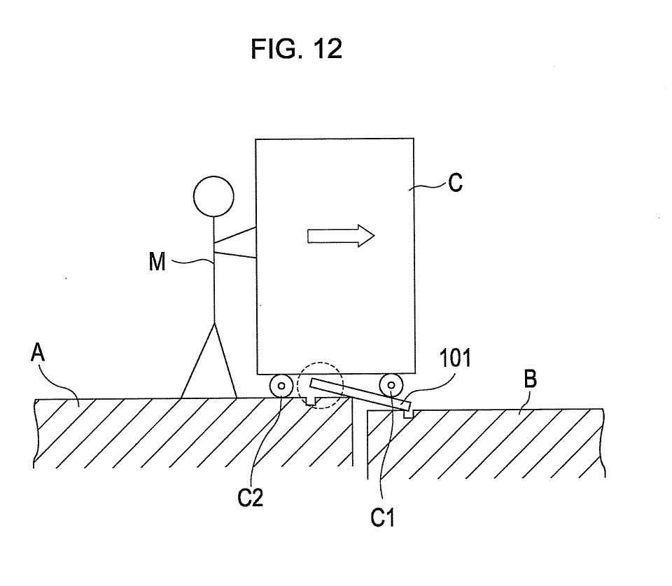

FIG. 13 is a view illustrating the conventional goods guiding device.

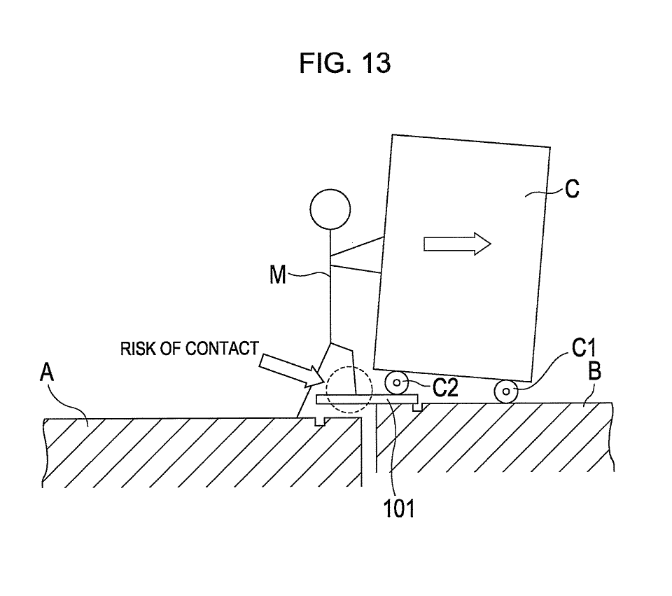

### DESCRIPTION OF EMBODIMENTS

A goods guiding device according to an embodiment will be described below with reference to the drawings.

### (A) Description of the Embodiment

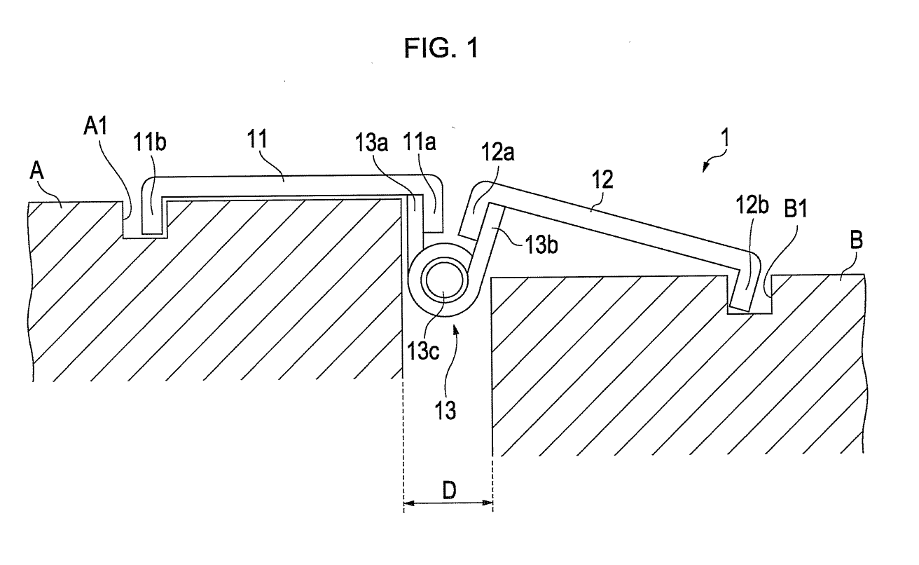

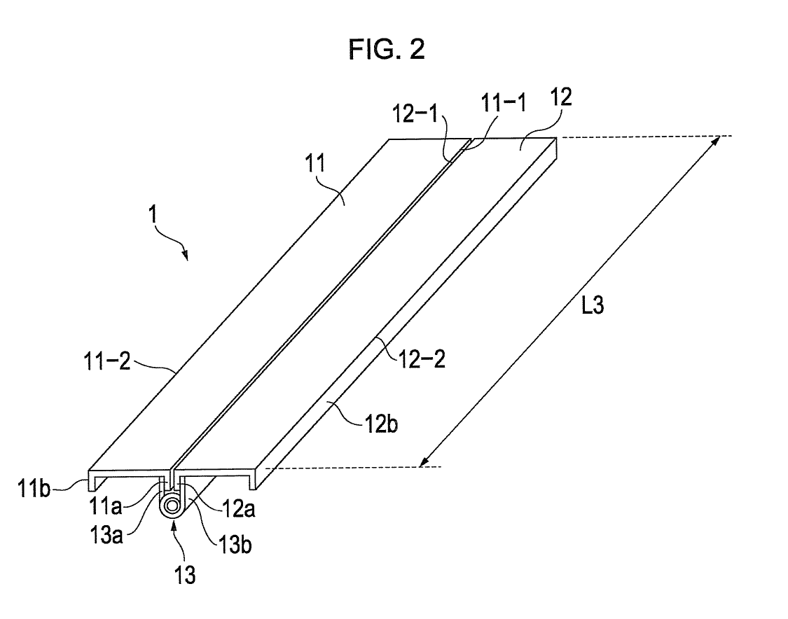

FIGS. 1 and 2 schematically illustrate the configuration of a goods guiding device according to an embodiment. FIG. 1 is a side view illustrating a usage state of the goods guiding device, and FIG. 2 is a perspective view schematically illustrating the outer appearance of the goods guiding device.

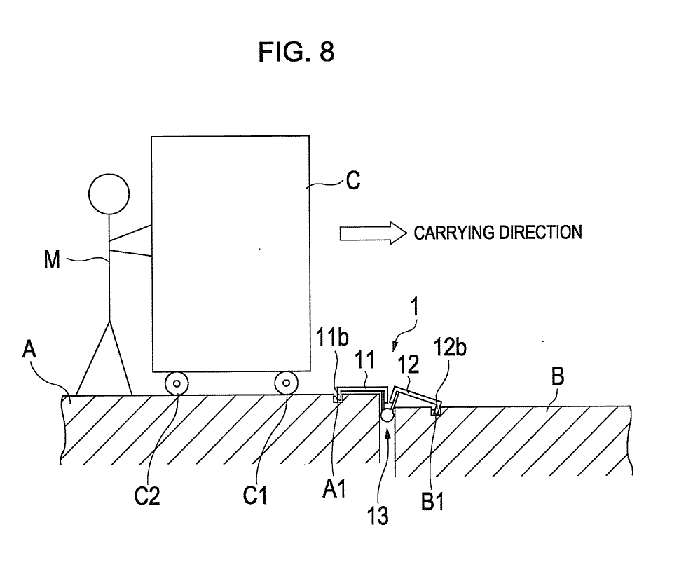

A goods guiding device 1 guides the article C between a first floor and a second floor. In this embodiment, the goods guiding device 1 is used to guide the article C to be fed between a landing floor (an example of “first floor”) A and a car floor (an example of “second floor”) B of an elevator, and a carrier M (see FIG. 8) carries the article C having casters C1 and C2 with the goods guiding device 1. The goods guiding device 1 guides the article C to be fed between a landing floor A and a car floor B over a gap. The gap is formed between the landing floor A and the car floor B.

In each of the casters C1 and C2, tires are provided near either end of an axle (not illustrated), and the tires are rotatable on the axle. These casters C1 and C2 are arranged near the bottom of the article C in a manner such that their axles are parallel to each other.

FIG. 1 illustrates a state in which the landing floor A is higher than the car floor B. The landing floor A and the car floor B are respectively provided with door guide grooves A1 and B1 for guiding the door (not illustrated) of the elevator.

In general, the door guide grooves A1 and B1 are often provided at thresholds on the landing floor A and the car floor B, respectively. In this embodiment, illustration of the thresholds is omitted for convenience.

The car floor B is provided at a distance D from the landing floor A. For example, the distance D is about 15 mm.

As illustrated in FIG. 1, the goods guiding device 1 includes a floor plate (an example of “first plate-shaped member”) 11, a floor plate (an example of “second plate-shaped member”) 12, and a hinge 13.

The floor plate 11 is placed on the landing floor A for supporting and guiding the article C fed from the landing floor A. The floor plate 12 is placed on the car floor B for supporting and guiding the article C fed to the car floor B. The floor plate 11 has a hook portion 11b engageable with a guide groove A1 formed at the landing floor A. The floor plate 12 has a hook portion 12b engageable with a guide groove B1 formed at the car floor B. The hinge 13 connects the floor plate 11 and the floor plate 12. The hinge protrudes downwardly from the surfaces of the floor plate 11 and the floor plate 12 for supporting and guiding the article C. The hinge 13 has a size adapted to the gap such that when the goods guiding device 1 placed between the landing floor A and the car floor B the hinge 13 will be accommodated within the gap, and engagement of the hinge 13 with the gap and the hook portions 11b, 12b with the guide grooves A1, B1, respectively, will provide a stable guide surface for feeding the article C.

The hinge 13 is formed on one side of the floor plates 11, 12 and connects the floor plates 11, 12. The hook portion 11b is formed on a side of the floor plate 11 opposite to the side on which the hinge 13 is formed. The hook portion 12b is formed on a side of the floor plate 12 opposite to the side on which the hinge 13 is formed.

As illustrated in FIG. 2, the floor plate 11 is formed by a rectangular plate-shaped member. The floor plate 11 is provided with L-shaped protruding portions 11a and 11b that are formed by bending portions near ends of longitudinal sides 11-1 and 11-2 at a right angle or at a substantially right angle in the same direction (downward in the plane of FIG. 1).

Further, the floor plate 11 is formed by a plate member having a thickness smaller than the width of the above-described door guide groove A1 of the landing floor A, and the protruding portion 11b can be inserted in the door guide groove A1.

Similarly to the floor plate 11, the floor plate 12 is formed by a rectangular plate-shaped member, as illustrated in FIG. 2. Similarly to the floor plate 11, the floor plate 12 is provided with L-shaped protruding portions 12a and 12b that are formed by bending portions near ends of longitudinal sides 12-1 and 12-2 at a right angle or at a substantially right angle in the same direction (downward in the plane of FIG. 1).

Further, the floor plate 12 is formed by a plate member having a thickness smaller than the width of the above-described door guide groove B1 of the car B, and the protruding portion 12b can be inserted in the door guide groove B1.

In addition, the floor plates 11 and 12 have almost the same length L3 in the longitudinal direction (in the depth direction in the plane of FIG. 2). The length L3 is set to be shorter than the frontage of the entrance of the elevator in which the goods guiding device 1 is mounted. Further, it is preferable that the length L3 be larger than the width of the above-described casters C1 and C2 of the article C in the axle direction.

Hereinafter, a surface of the floor plate 11 from which the protruding portions 11a and 11B protrude is sometimes referred to as a back surface and the opposite surface is sometimes referred to as a front surface. Similarly, a surface of the floor plate 12 from which the protruding portions 12a and 12B protrude is sometimes referred to as a back surface and the opposite surface is sometimes referred to as a front surface.

In other words, the protruding portions 11a and 11b stand from the back surface of the floor plate 11 along the sides 11-1 and 11-2. Also, the protruding portions 12a and 12b stand from the back surface of the floor plate 12 along the sides 12-1 and 12-2.

In the hinge 13, for example, ends of two blades 13a and 13b are wound around a bushing 13c, so that the blades 13a and 13b can turn on the bushing 13c. The hinge 13 can be realized by various known hinges.

The blade 13a of the hinge 13 is attached in parallel to the protruding portion 11a of the floor plate 11 in a manner such that the bushing 13c extends in the longitudinal direction of the floor plate 11. The blade 13b of the hinge 13 is attached in parallel to the protruding portion 12a of the floor plate 12 in a manner such that the bushing 13c extends in the longitudinal direction of the floor plate 12. The blade 13a and the protruding portion 11a are fixed by welding or by other methods. Similarly, the blade 13b and the protruding portion 12a are fixed by welding or other methods.

That is, the protruding portions 11a and 12a function as joint portions for connecting the hinge 13 to the floor plates 11 and 12.

By pivoting the floor plate 11 and the floor plate 12 on the bushing 13c of the hinge 13, the front surface of the floor plate 11 and the front surface of the floor plate 12 can be made flush with each other, as illustrated in FIG. 2. Further, by being pivoted on the bushing 13c of the hinge 13, the floor plate 11 and the floor plate 12 can be folded down, so that the back surfaces of the floor plate 11 and the floor plate 12 face each other (not illustrated). That is, the hinge 13 connects the floor plate 11 and the floor plate 12 so that the floor plates can pivot on the bushing 13c.

Hereinafter, a state in which the front surface of the floor plate 11 and the front surface of the floor plate 12 are flush with each other, as illustrated in FIG. 2, is sometimes referred to as an unfolded state. Further, hereinafter, a state in which the floor plate 11 and the floor plate 12 are folded down at the hinge 13 and the back surfaces of the floor plate 11 and the floor plate 12 face each other is sometimes referred to as a folded state.

The goods guiding device 1 can arbitrarily change its shape between the unfolded state and the folded state by pivoting the floor plate 11 and the floor plate 12 on the bushing 13c of the hinge 13.

Hereinafter, a surface defined by the front surface of the floor plate 11 and the front surface of the floor plate 12 in the unfolded state of the goods guiding device 1 is sometimes referred to as an article passing surface.

The blade 13a is attached to a side of the protruding portion 11a of the floor plate 11 opposing the protruding portion 11b, and the blade 13b is attached to a side of the protruding portion 12a of the floor plate 12 opposing the protruding portion 12b. With this structure, even when the hinge 13 is brought into an unfolded state by pivoting the floor plate 11 and the floor plate 12, the blades 13a and 13b will not be caught between the protruding portion 11a of the floor plate 11 and the protruding portion 12a of the floor plate 12, and will not hinder pivotal motion of the floor plates.

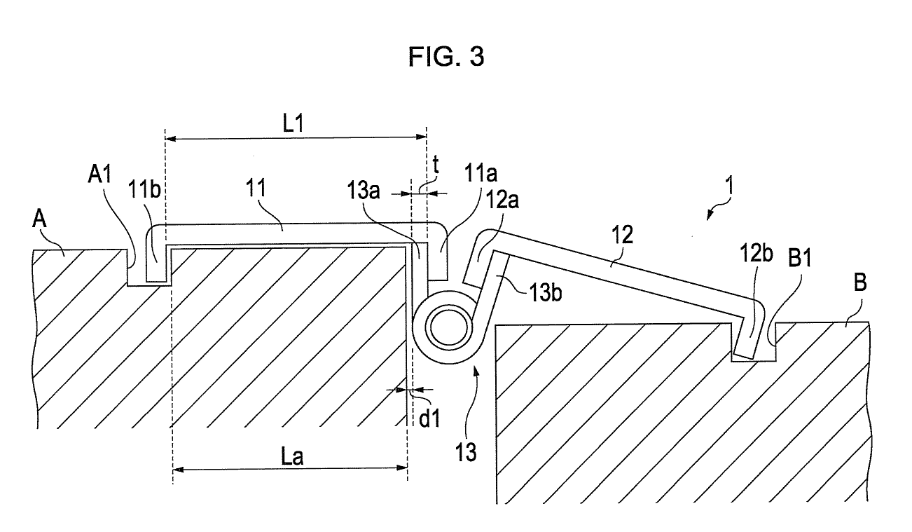

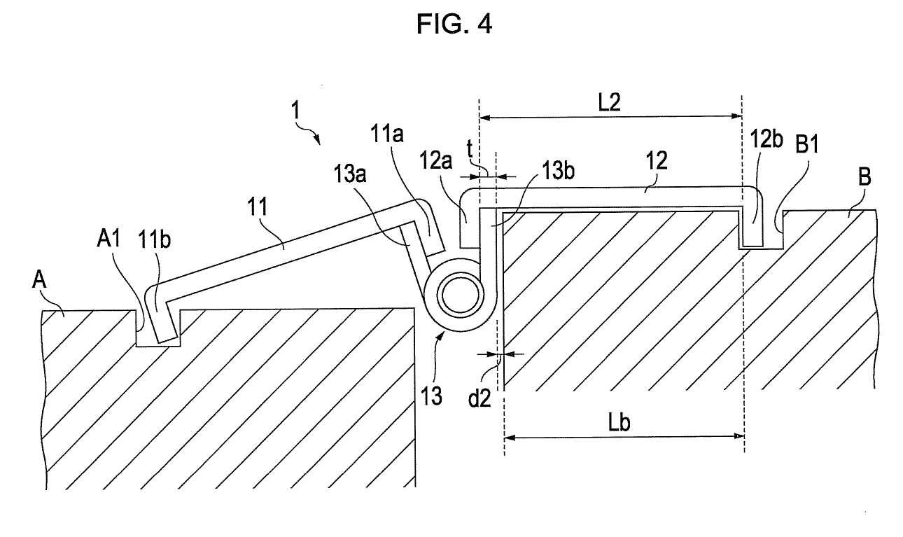

Next, a description will be given of the dimensions of the floor plates 11 and 12 in the transverse direction. FIGS. 3 and 4 are side views illustrating the dimensions of the floor plates in the goods guiding device of the embodiment.

As illustrated in FIG. 3, a length L1 between the protruding portion 11a and the protruding portion 11b on the back surface of the floor plate 11 is given as the sum of a distance La from an end of the landing floor A closer to the car B to the door guide groove Al, a thickness t of the blade 13a of the hinge 13, and a gap d1 between the end of the landing floor A and the blade 13a by Expression (1):

L1=La+t+d1 (1)

By setting the gap d1 to be larger than zero, when the floor plate 11 is placed with its back surface facing the landing floor A, the hinge 13 protrudes between the landing floor A and the car floor B in a state in which the protruding portion 11b is inserted in the door guide groove A1, and the protruding portion 11b and the hinge 13 clamp the landing floor A with some allowance.

On the other hand, as illustrated in FIG. 4, a length L2 between the protruding portion 12a and the protruding portion 12b on the back surface of the floor plate 12 is given by Expression (2) from the sum of a distance Lb from an end of the car floor B closer to the landing floor A to the door guide groove B1, a thickness t of the blade 13b of the hinge 13, and a gap d2 between the end of the car floor B and the blade 13b:

L2=Lb+t+d2 (2)

By setting the gap d2 to be larger than zero, when the floor plate 12 is placed with its back surface facing the car floor B, the hinge 13 protrudes between the landing floor A and the car floor B in a state in which the protruding portion 12b is inserted in the door guide groove B1, as illustrated in FIG. 4, and the protruding portion 12b and the hinge 13 clamp the car floor B with some allowance.

In the goods guiding device 1, it is preferable that the gap d1 between the end of the landing floor A and the blade 13a and the gap d2 between the end of the car floor B and the blade 13b be as small as possible without hindering placement of the floor plate 11 on the landing floor A and placement of the floor plate 12 on the car floor B.

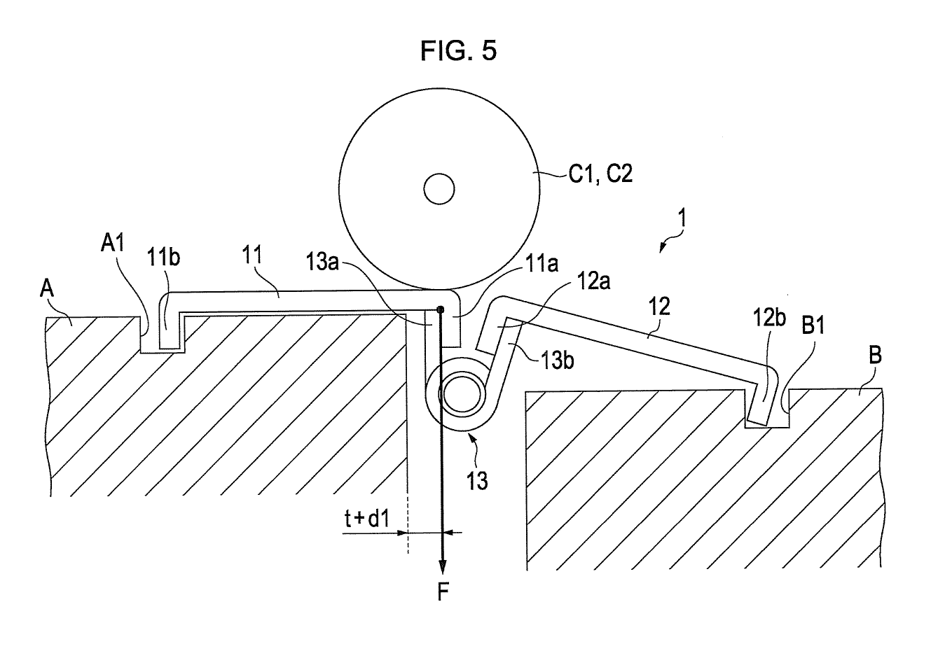

FIGS. 5 to 7 are side views explaining the rotational moment produced in the goods guiding device 1 of the embodiment

In an example illustrated in FIG. 5, the caster C1 (C2) of the article C is located nearly on the protruding portion 11a of the floor plate 11 on the article passing surface of the goods guiding device 1. That is, FIG. 5 illustrates a state in which the caster C1 (C2) of the article C is located near the end of the floor plate 11 closer to the floor plate 12 on the article passing surface of the goods guiding device 1.

In the goods guiding device 1, a rotational moment M produced in the floor plate 11 by the caster C1 (C2) in the state illustrated in FIG. 5 is given by the following Expression (3):

M=F×(t+d1) (3)

In the above Expression (3), F represents the weight of the article C put by the caster C1 (C2).

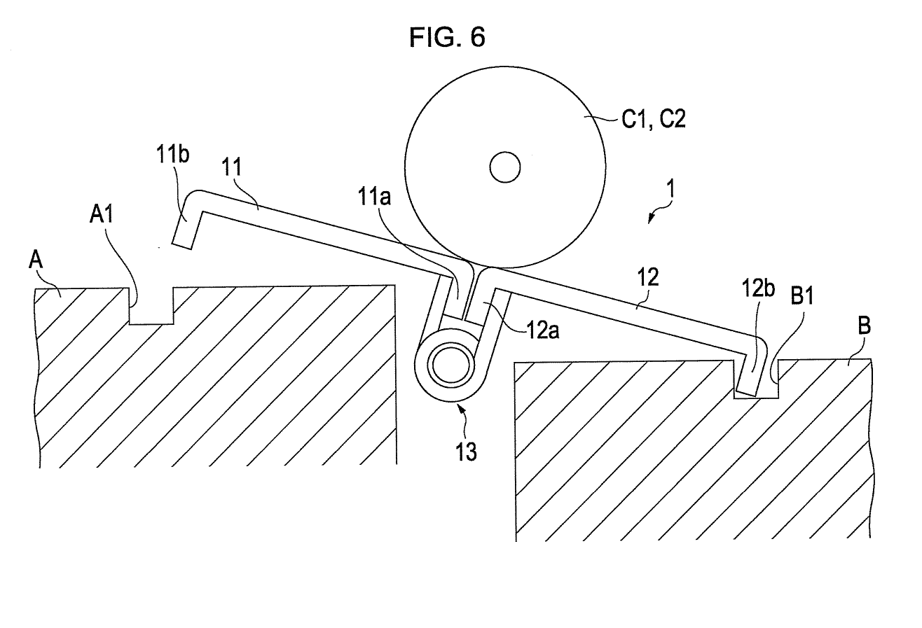

When the gap d1 between the end of the landing floor A and the blade 13a is large, the above-described rotational moment M is large, and the end of the floor plate 11 at the protruding portion 11b is easily raised by the rotational moment M, as illustrated in FIG. 6.

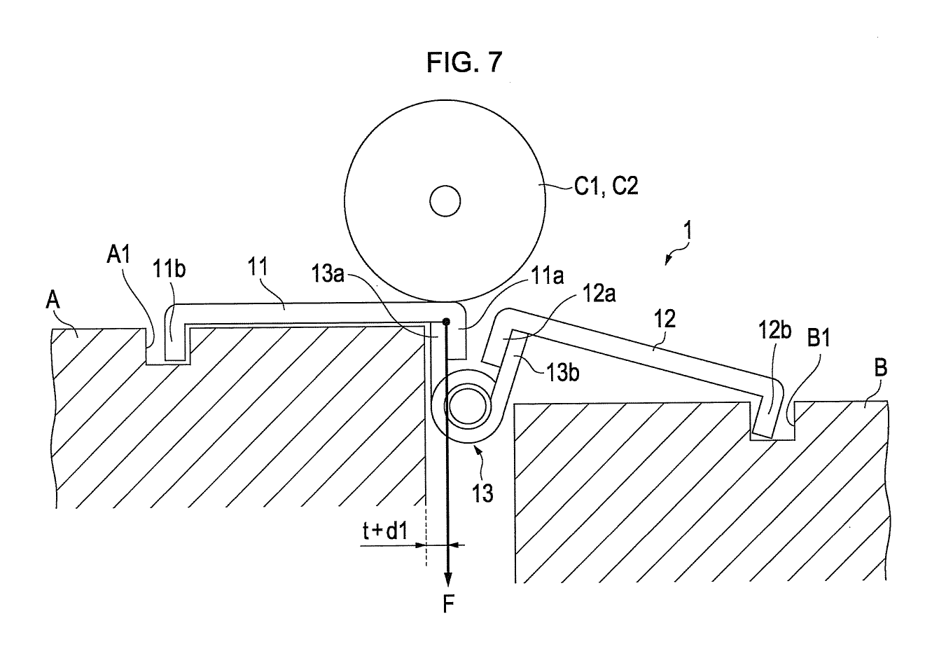

In contrast, when the gap d1 between the end of the landing floor A and the blade 13a is decreased, the above-described rotational moment M decreases, and this can prevent the end of the floor plate 11 at the protruding portion 11b from being raised by the rotational moment M, as illustrated in FIG. 7.

Similarly, in the floor plate 12, in a case in which the gap d2 between the end of the car floor B and the blade 13b is large, when the caster C1 (C2) is present near the protruding portion 12a on the article passing surface, the rotational moment M produced by the caster C1 (C2) is large. That is, the end of the floor plate 12 at the protruding portion 12b is easily raised by the rotational moment M.

In contrast, when the gap d2 between the end of the car floor B and the blade 13b is decreased, the above-described rotational moment M decreases, and this can prevent the end of the floor plate 12 at the protruding portion 12b from being raised by the rotational moment M.

Even if the ends of the floor plates 11 and 12 are raised by the above-described rotational moment M, the amount of raise can be reduced by decreasing the gaps d1 and d2.

As illustrated in FIGS. 3 and 4, when a level difference is formed between the landing floor A and the car floor B, the back surface of only one of the floor plates 11 and 12 that is placed on the upper floor (the floor plate 11 in FIG. 3, the floor plate 12 in FIG. 4) is in contact with the landing floor A or the car floor B. The other floor plate 12 or 11 is fixed at one end to the hinge 13, and is inserted at the other end in the door guide groove B1 or the door guide groove Al. Thus, the other floor plate 12 or 11 forms a slope that linearly connects the hinge 13 to the door guide groove B1 or the door guide groove A1.

In other words, even when a level difference is formed between the landing floor A and the car floor B in the goods guiding device 1, the floor plate 11 or 12 (e.g., the floor plate 12 in FIG. 3) placed on the lower one (e.g., the car floor B in FIG. 3) of the floors that form the level difference forms a slope for eliminating the level difference.

In this case, the hinge 13 is stored (inserted) in the space formed between the landing floor A and the car floor B. Hence, the hinge 13 does not push up the article passing surface of the goods guiding device 1.

FIG. 8 is a side view illustrating a method for using the goods guiding device 1 of the embodiment.

As illustrated in FIG. 8, the carrier M places the floor plate 11 of the goods guiding device 1 on the landing floor A, places the floor plate 12 on the car floor B, and sets the hinge 13 in a manner such as to protrude between the landing floor A and the car floor B.

In this case, the carrier M inserts the protruding portion 11b of the floor plate 11 in the door guide groove A1 of the landing floor A, and inserts the protruding portion 12b of the floor plate 12 in the door guide groove B1 of the car floor B.

Even when there is a level difference between the landing floor A and the car floor B, the floor plate 11 (12) placed on the lower floor pivots on the hinge 13, and the end of the floor plate 11 (12) opposite the side connected to the hinge 13 follows and contacts the lower floor. The floor plate 11 (12) placed on the lower floor thereby forms a slope that the article C to be fed between the landing floor A and the car floor B.

For example, in the example illustrated in FIG. 8, the car floor B is lower than the landing floor A. In this case, the floor plate 12 placed on the car floor B pivots on the hinge 13, and the protruding portion 12b thereof comes into contact with the car floor B at the door guide groove B1. Thus, the floor plate 12 forms a slope that connects the car floor B and the landing floor A.

Then, the carrier can smoothly move the article C from the landing floor A to the car floor B by pushing and moving the article C over the slope formed by the front surface of the floor plate 11 (12) of the goods guiding device 1, as described above.

In this way, according to the goods guiding device 1 of the embodiment, it is possible to easily move the article.

In this case, since the hinge 13 is stored in the space between the landing floor A and the car floor B, a projection is not formed on the article passing surface by the hinge 13. This allows the article to be moved smoothly.

According to the goods guiding device 1, the height difference between the landing floor A or the car floor B, and the article passing surface of the goods guiding device 1 is equal to the thickness of the floor plate 11 or the floor plate 12. That is, the height difference between the landing floor A or the car floor B, and the article passing surface of the goods guiding device 1 can be reduced, and the article C can be carried stably. For example, the article C can be prevented from falling down on the goods guiding device 1. Moreover, the carrier or the like can be prevented from tripping over the goods guiding device 1, and this can improve safety.

Since the floor plate 11 and the floor plate 12 are connected by the hinge 13, when the article C is moved on the article passing surface, the ends of the floor plates 11 and 12 are not raised, and the article can be carried safely and smoothly.

In addition, even when the level difference between the landing floor A and the car floor B changes during use of the goods guiding device 1, the floor plates 11 and 12 pivot on the hinge 13 to follow the change in level difference, so that the change in level difference can be overcome.

In the goods guiding device 1, the floor plate 11 has the protruding portion 11b and the floor plate 12 has the protruding portion 12b. These protruding portions are inserted in the door guide groove A1 of the landing floor A and the door guide groove B1 of the car floor B. This can prevent the goods guiding device 1 from moving in a direction along the landing floor A and the car floor B (hereinafter sometimes referred to a carrying direction).

Hence, even when the carrier moves the article C on the goods guiding device 1 and a load for moving the goods guiding device 1 in the carrying direction is applied by the casters C1 and C2 or the like, the protruding portions 11b and 12b come into contact with the inner walls of the door guide grooves A1 and B1. Consequently, the protruding portions 11b and 12b prevent the goods guiding device 1 from moving in the carrying direction. That is, the goods guiding device 1 is fixed to the landing floor A and the car floor B, and the article C can be carried stably. This increases reliability.

By setting the gap d1 between the end of the landing floor A and the blade 13a and the gap d2 between the end of the car floor B and the blade 13b at small values, the floor plate 11 and the floor plate 12 can be prevented from being raised. This improves safety.

Moreover, since the floor plate 11 and the floor plate 12 can be folded down at the hinge 13, when the floor plates are brought into a folded state when not in use, the goods guiding device 1 can be carried and stored easily.

Since the protruding portions 11a, 11b, 12a, and 12b are formed by bending the ends of the floor plates 11 and 12 along the sides at a right angle, they can be produced easily and at low cost. That is, it is possible to reduce the number of components of the goods guiding device 1 and to reduce the production cost.

Further, in the goods guiding device 1, the blade 13a of the hinge 13 is fixed in parallel to the protruding portion 11a protruding straight from the floor plate 11, and the blade 13b of the hinge 13 is fixed in parallel to the protruding portion 12a protruding straight from the floor plate 12. Hence, even when a load in the carrying direction is applied to the floor plate 11 and the floor plate 12 by the article C or the like during use of the goods guiding device 1, the load does not act in a direction to separate the protruding portion 11a and the blade 13a, and the protruding portion 12a and the blade 13b.

### (B) Description of Modifications

The disclosed goods guiding device 1 is not limited to the above-described embodiment, and can be carried out by various modifications without departing from the gist of the embodiment.

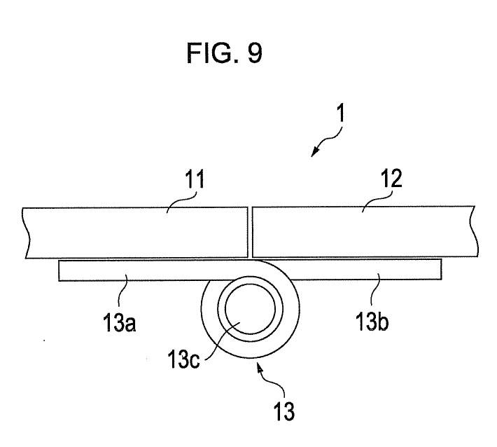

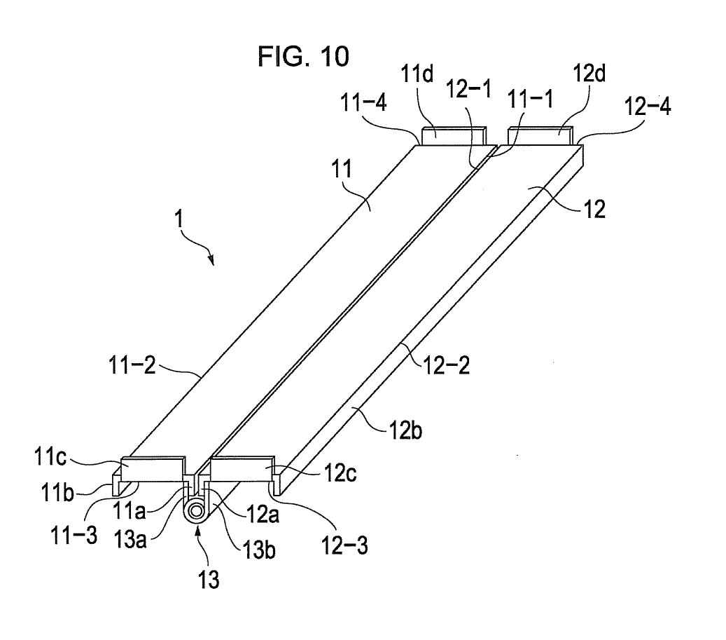

FIGS. 9 and 10 schematically illustrate the configurations of modifications of the goods guiding device 1 of the embodiment. FIG. 9 is a side view partially illustrating a hinge 13 and its surroundings, and FIG. 10 is a perspective view schematically illustrating the outward appearance of a modification.

FIG. 9 illustrates a modification in which the floor plates 11 and 12 in the above-described embodiment are not provided with the protruding portions 11a and 12a. That is, instead of attaching the blades 13a and 13b of the hinge 13 to the protruding portions 11a and 12a, the blade 13a of the hinge 13 is fixed to the back surface of the floor plate 11 in a manner such that the back surface of the floor plate 11 is parallel to the blade 13a. Similarly, the blade 13b of the hinge 13 is fixed to the back surface of the floor plate 12 in a manner such that the back surface of the floor plate 12 is parallel to the blade 13b.

According to the modification illustrated in FIG. 9, the production cost of the goods guiding device 1 can be reduced because of absence of the protruding portions 11a and 12a in the floor plates 11 and 12.

In contrast, in a modification illustrated in FIG. 10, extended portions 11c and 11d perpendicular or substantially perpendicular to the front surface of the floor plate 11 are respectively provided on opposite sides extending straight from the sides where the protruding portions 11a and 11b are provided.

Extended portions 11c and 11d are provided on side which is perpendicular to the side the hinge 13 is formed on, the stand extending upwardly from the surfaces of the floor plates 11, 12 opposite toward the protruding direction of the hinge 13.

That is, in the modification illustrated in FIG. 10, the extended portions 11c and 11d perpendicular or substantially perpendicular to the front surface of the floor plate 11 are respectively provided on shorter sides 11-3 and 11-4 of the floor plate 11.

These extended portions 11c and 11d stand from the front surface of the floor plate 11 along the sides 11-3 and 11-4.

The extended portions 11c and 11d are formed by bending ends of the shorter sides 11-3 and 11-4 of the floor plate 11 along the sides at a right angle (into an L-shape). That is, the extended portions 11c and 11d are provided along the shorter sides 11-3 and 11-4 of the floor plate 11 in a manner such that the article passing surface is provided therebetween.

Similarly, extended portions 12c and 12d perpendicular or substantially perpendicular to the front surface of the floor plate 12 are respectively provided on opposite sides extending straight from the sides where the protruding portions 12a and 12b are provided.

The extended portions 12c and 12d stand from the front surface of the floor plate 12 along sides 12-3 and 12-4.

That is, in the modification illustrated in FIG. 10, the extended portions 12c and 12d perpendicular or substantially perpendicular to the front surface of the floor plate 12 are respectively provided on the shorter sides 12-3 and 12-4 of the floor plate 12.

These extended portions 12c and 12d are formed by bending ends of the shorter sides 12-3 and 12-4 of the floor plate 12 along the sides at a right angle. That is, the extended portions 12c and 12d are respectively provided along the shorter sides 12-3 and 12-4 of the floor plate 12 in a manner such that the article passing surface is provided therebetween.

By forming the extended portions 11c, 11d, 12c, and 12d in the floor plates 11 and 12, the strength of the floor plates 11 and 12 can be increased. Further, the extended portions 11c, 11d, 12c, and 12d function as guide portions that prevent the article C from coming out of the article passing surface and falling off the goods guiding device 1 when the carrier moves the article C on the goods guiding device 1. This can enhance convenience and safety.

By being formed by bending the ends of the floor plates 11 and 12 along the sides at a right angle, the extended portions 11c, 11d, 12c, and 12d can be produced easily and at low cost.

The extended portions 11c, 11d, 12c, and 12d are not limited to extended portions formed by bending the ends of the floor plates 11 and 12 along the sides at a right angle, and various modifications can be made without departing from the gist of the embodiment.

For example, the extended portions 11c, 11d, 12c, and 12d may be formed by continuously or intermittently placing some members at the ends of the shorter sides 11-3, 11-4, 12-3, and 12-4 of the floor plates 11 and 12 on the article passing surface of the goods guiding device 1. Alternatively, the extended portions 11c, 11d, 12c, and 12d may be formed by intermittently bending the ends of the floor plates 11 and 12 along the sides at a right angle.

From the above disclosure, the embodiment can be practiced and produced by those skilled in the art.

All examples and conditional language recited herein are intended for pedagogical purposes to aid the reader in understanding the invention and the concepts contributed by the inventor to furthering the art, and are to be construed as being without limitation to such specifically recited examples and condition, nor does the organization of such examples in the specification relate to a showing of superiority and inferiority of the invention. Although the embodiment of the present inventions have been described in detail, it should be understood that the various changes, substitutions, and alternations could be made hereto without departing from the spirit and scope of the invention.

What is claimed is:

1. A device for guiding goods to be fed between a first floor and a second floor over a gap formed between the first and second floors, the device comprising:
a first plate member to be placed on the first floor for supporting and guiding the goods fed from the first floor;
a second plate member to be placed on the second floor for supporting and guiding the goods fed to the second floor, at least one of the first and second plate members having a hook portion engageable with a groove formed on at least one of the first and second floors; and
a hinge connecting the first plate member and the second plate member, the hinge protruding downwardly from the surfaces of the first and second plate member for supporting and guiding the goods, the hinge having a size adapted to the gap such that when the device placed between the first and second floors, the hinge can be accommodated within the gap, and engagement of the hinge with the gap and the hook portion with the groove provides a stable guide surface for feeding the goods.

2. The device according to claim 1, wherein the hinge is formed on one side of the first and second plate member and connects the first and second plate member, and the hook portion is formed on a side of at least one of first and second plate members opposite to the side on which the hinge is formed.

3. The device according to claim 1, wherein at least one of the first and second plate members is formed by a rectangular plate member and the hinge is formed on one side of the first and second plate members, and further comprising:
a extended portion being provided on side which is perpendicular to the side the hinge is formed on, the stand extending upwardly from the surfaces of the first and second plate member opposite toward the protruding direction of the hinge.

4. A method for guiding goods to be fed between a first floor and a second floor over a gap formed between the first and second floors, the method comprising:
placing a first plate member on the first floor for supporting and guiding the goods fed from the first floor;
placing a second plate member on the second floor for supporting and guiding the goods fed to the second floor, at least one of the first and second plate members having a hook portion engageable with a groove formed at least one of the first and second floors; and
placing a hinge connecting the first plate member and the second plate member, the hinge protruding downwardly from the surfaces of the first and second plate member for supporting and guiding the goods, the hinge having a size adapted to the gap such that when the device placed between the first and second floors the hinge will be accommodated within the gap, and engagement of the hinge with the gap and the hook portion with the groove will provide a stable guide surface for feeding the goods.
